(19) United States
(12) Patent Application Publication
(10) Pub. No.: US 2002/0036655 A1
(43) Pub. Date: Mar. 28, 2002

(54) Method and multi-media product for display of real-time information

(76) Inventors: Yoni Yulevich, Herzeliya (IL); Tamir Yulevich, Galgaley Haplada (IL)

Correspondence Address: SUGHRUE MION ZINN MACPEAK & SEAS, PLLC, 2100 Pennsylvania Avenue, NW, Washington, DC, 20037-3213, US

(21) Appl. No.: 09/948,562

(22) Filed: Sep. 10, 2001

Related U.S. Application Data
(60) Provisional application No. 60/231,169, filed on Sep. 8, 2000.

(51) Int. Cl. G06F 3/00

(52) U.S. Cl. 345/744

(57) ABSTRACT

A method for displaying user selected content information and portal selected advertising, and a system using the method, wherein the method comprises receiving from a remote information server at a portal a first group of user selected content information and a first group of portal selected advertising information according to a schedule predefined by a user. The method further includes storing the first group of user selected content information and the first group of portal selected advertising information on a storage medium of the user device. In addition, the method includes detecting by the user device a predetermined period in which no user input is received by the user device, and then displaying simultaneously on the user device the first group of user selected content information and the first group of portal selected advertising information after the predetermined period has elapsed from the storage medium of the user device. The method also is capable of cycling between portions of the first group of user selected content information and portions of the first group of portal selected advertising information automatically without input from the user.

### TECHNICAL FIELD

The present invention relates to a multi-media product for presenting, on a user device, real-time information and advertising, as well as updated information of preprogrammed domains according to a user selection and definition. More specifically, the invention is directed to a method, software program product and computer system for displaying information, such as global and regional news on a real time basis and advertising, the display of information being implemented into a screen saver or independent application.

### BACKGROUND

Conventional screen savers display a selected image or sequence of images which are pre-programmed to display on a computer screen during times of nonuse. Screen savers were originally designed to prevent the overuse of pixels in a computer monitor by changing the on-state of each pixel frequently at times when a user was not using the computer. The conventional screen saver is not designed to convey useful information for assimilation by a user, but rather designed for entertainment purposes of a user. In contemporary computer monitors, the screen saver is no longer needed, as the refresh rate of current monitors has a frequency which prevents pixel damage. Accordingly, the conventional screen saver is essentially useless for anything other than entertainment value.

### SUMMARY OF THE INVENTION

In one non-limiting embodiment of the present invention, a method is disclosed for displaying user selected content information and portal selected advertising, which comprises receiving from a remote information server at a portal a first group of user selected content information and a first group of portal selected advertising information according to a schedule predefined by a user, and storing the first group of user selected content information and the first group of portal selected advertising information on a storage medium of the user device. The method further includes detecting by the user device a predetermined period in which no user input is received by the user device, and then displaying simultaneously on the user device the first group of user selected content information and the first group of portal selected advertising information after the predetermined period has elapsed from the storage medium of the user device. The method also is capable of cycling between portions of the first group of user selected content information and portions of the first group of portal selected advertising information automatically without input from the user.

In another non-limiting embodiment of the present invention, a computer system is disclosed for displaying user selected content information and portal selected advertising, which comprises a remote information server, and a user device. The user device further includes a processor, a display, a storage medium and an interface. The interface operates to receive a first group of user selected content information and a first group of portal selected advertising information from the remote information server according to a schedule predefined by a user. The storage medium operates to store the first group of user selected content information and the first group of portal selected advertising information. The processor operates to detect a predetermined period in which no user input is received by the computer system, to simultaneously display the first group of user selected content information and the first group of portal selected advertising information on the display after the predetermined period has elapsed, to cycle between portions of the first group of user selected content information automatically without input from the user; and to cycle between portions of the first group of portal selected advertising information automatically without input from the user.

### BRIEF DESCRIPTION OF THE DRAWINGS

For a better understanding of the illustrative embodiments of the present invention, reference may be made to the accompanying drawings in which:

FIG. 1 is a schematic view of a computer system for displaying user selected content information and portal selected advertising according to one embodiment of the present invention;

FIG. 2 is a flow chart illustrating one method of operation of the computer system illustrated in FIG. 1;

FIG. 3 is a flow chart illustrating one process related to the present invention;

FIG. 4A is a flow chart illustrating another process related to the present invention;

FIG. 4B is a flow chart further illustrating the process illustrated in FIG. 4A;

FIG. 5A is a schematic illustration of a user device display implementing the present invention according to an embodiment of the present invention; and

FIG. 5B is a schematic illustration of a user device display implementing the present invention according to another embodiment of the present invention.

### DETAILED DESCRIPTION

The following description of the embodiments discloses specific configurations, features, and operations. However, the embodiments are merely examples of the present invention, and thus, the specific features described below are merely used to more easily describe such embodiments and to provide an overall understanding of the present invention. Accordingly, one skilled in the art will readily recognize that the present invention is not limited to the specific embodiments described below. Furthermore, the descriptions of various configurations, features, and operations of the present invention that would have been known to one skilled in the art are omitted for the sake of clarity and brevity.

According to one embodiment of the present invention, a software product is provided which may be used as a screen saver application or alternatively, an independent application program. The inventive software works as an integral program on a user device, for example, a personal computer, to combine the innovations of multimedia technology with the advanced technologies of the Internet. For example, the application, implemented as a screen saver, may display user selected content information including updated stock quotes, game scores, news headlines, etc., on the screen saver during computer nonuse periods, or in an independent application at the command of a user. As used herein, the term “real-time,” is defined as meaning frequently updated, as often as a web site may update such information.

The inventive application has advantages not only for a computer (user device) user, but for the source provider of the information or “portal,” as well as product advertisers. For example, a portal may provide user selected or requested content information to the software application through the user's Internet connection, via a web browser. Depending on the configuration of the software application, the user device may automatically intermittently access the portal, but this is not necessary. Nevertheless, the application enables a connection to be made with the Internet's information sources, or “portals,” by using a conventional web browser.

The inventive application enables a portal and other related information sources to distribute global and local user selected content information and advertising to the display of a user device on a real-time basis. In one implementation, the user and portal benefit by the frequent delivery of content information to the user device with no involvement of the user, whatsoever, during a time that the user device is not in use, i.e., when a screen saver is activated. Additionally, the portal and its advertisers gain increased coverage by the automatic transfer and display of advertisements to the user's device via the inventive software application.

The portals, using communication technologies which may include, for example, wireless application protocol (WAP) and cellular, may deliver information directly to a user's display, without involvement or request by the user.

On illustrative embodiment of the present invention enables a dynamic screen saver that displays to the user, a variety of desired content information, which can be individually adjusted by the user. The dynamic screen saver according to one aspect of the embodiment is customized by the user to receive and display content information in which the user has an interest, as opposed to the conventional screen saver that has no added value to the user.

The inventive product enables a user to receive user determined real time updates to the content information directly from multiple media sources directly to the user device display, without any active participation by the user. Additionally, the user may receive real time applications and utilities, such as a clock or interactive game, as well as portal selected advertising, with no interruption or disturbance by the advertising, because any advertising is displayed while the computer is not in use, as a background, similar to a conventional screen saver.

Another illustrative embodiment of the present invention enables the an advertiser to produce a direct, interactive multimedia advertisement directly to a display on a user device, without involvement or interference by the user. These advertisements are less intrusive or offensive to the user, as the advertiser, through the particular portal, utilizes the time when the user device is not in use to display its advertisements. The advertiser, through the use of the inventive application, is able to send subtle and continuous advertisements directed to the user, without the user's interaction.

The software product of an illustrative embodiment of the present invention is installed on a user computer as a screen saver, but can operate as an autonomous program as well. In a non-limiting implementation, the computer program product may be developed with applications including FLASH, VB, C++, ASP, WML, WINSOCK, and communication protocols such as, WAP, FTP and HTTP.

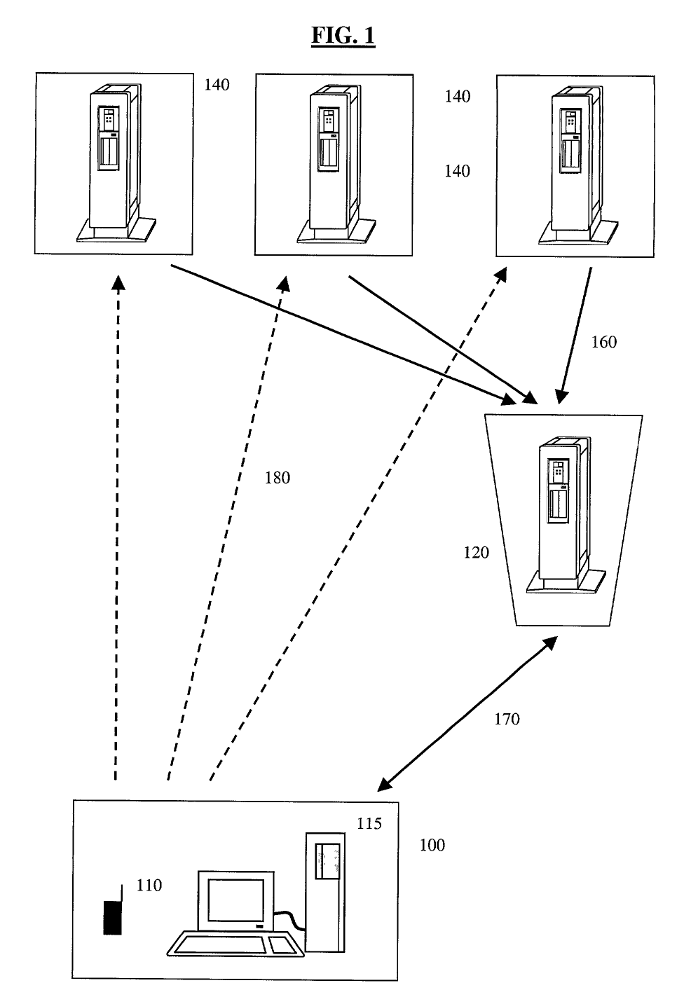

Referring now to FIG. 1, there is shown an exemplary embodiment of a computer system for displaying user selected content information and portal selected advertising. The computer system includes a user device 100 which may include, for example, a wireless (cellular) telephone 110, a personal computer 115, and a personal digital assistant (PDA)(not shown), or the like. The computer system also includes an information/application server 120 which initially provides a user application program to the user device 100 and subsequently provides user selected content information and portal selected advertising to the user device 100. The information sources or “portals” 140 supply the content information and advertising to the information server 120 through the communication network 160. The communication network 160 may be, for example, a local area network (LAN), a wide area network (WAN), the Internet, a wireless network using cellular or Wireless Application Protocol (WAP), an over-the-air broadcast network, a satellite communication network, or a direct modem connection network. The connection 170 between the information/application server 120 and the user device 100 may be a conventional terrestrial Internet connection, or may be a wireless connection using, for example, Wireless Application Protocol (WAP). Alternatively, the connection 170 may comprise a connection similar to the communication network 160. The user device 100, by activating a link within the user selected content information or advertising information, may communicate directly with the portals 140 through a connection 180 similar to the connection 160 or 170.

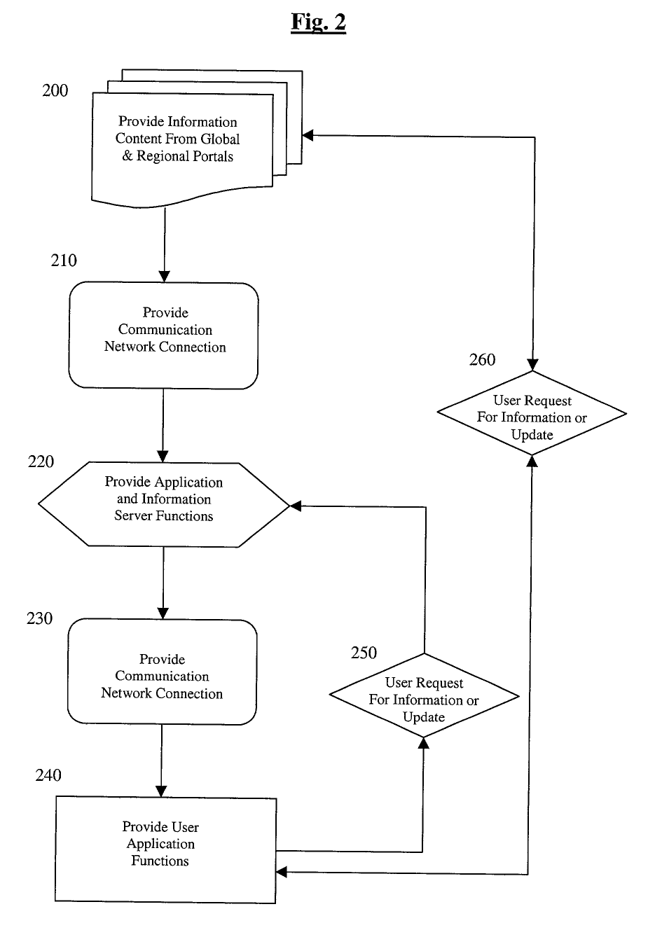

Referring now to FIG. 2, the method of operation of the computer system illustrated in FIG. 1 will now be generally described. In operation 200, information is provided through the portals 140 to the information server 120. A communication network connection 160 from the various portals 140 to the information server 120 is provided in operation 210. In operation 220, the information received from the portals 140 over the network connection 160 is cataloged and provided to the user device 100. A communication network connection 170, as previously described, is provided in operation 230, such that the information received by the information server 120 may be provided from the information server 120 to the user device 100. In operation 240, the information is provided to the user device 100 and the inventive user application operates to display the provided information. In operation 250, the user may request information from the information server 120. In such a request, the user device 100 may automatically request an update of the user selected content information and advertising, or the user may update his or her particular user profile. In operation 260, the user may activate a link within the selected content information and/or advertising, sending a request to the provider of the content information or advertising for additional information. Operation 260 may be implemented using, for example, a conventional Internet connection and Internet browser.

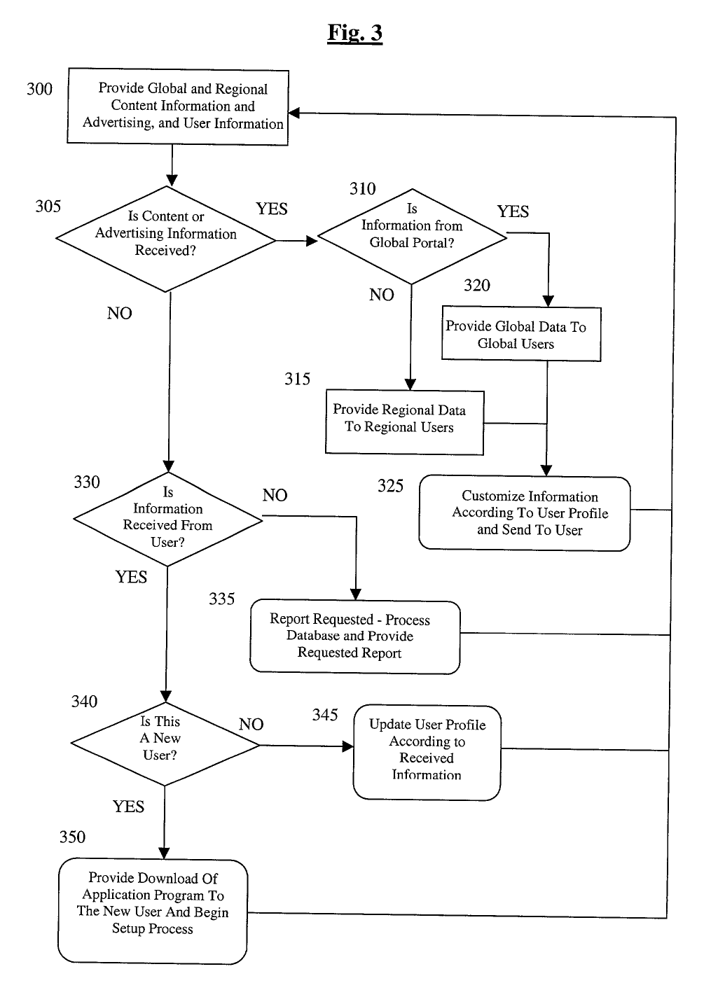

With reference to FIG. 3, a server based application according to an illustrative embodiment of the present invention is illustrated. In operation 300, content information, advertising and user information is provided to the information/application server 120. This information is then catergorized accordingly. In operation 305, a determination is made as to which category of information is received. If the received information is user selected content information or advertising information, then the application proceeds to operation 310. Otherwise, the application proceeds to operation 330. In operation 310, another determination is made as to whether the information is from a global portal 140 or region portal 140. If the received information is from a region portal 140, then in operation 315 this information is provided to regional (local) users of the application. Otherwise the information is provided in operation 320 to the global (international) users. This information is then customized and transmitted to the particular users according to the particular user's profile. (Operation 325). In operation 330, a determination is made as to whether the information is received from an existing user to which the user application according to the embodiment has been previously installed. If so, the application proceeds to operation 340. Otherwise, the application proceeds to operation 335. In operation 335, a determination is made that a report is requested from a database on the information/application server 120, and such a report is generated. In operation 340, if a determination is made that the user is a preexisting user, then in operation 345, the user's profile is updated according to the received information and the updated profile is stored in the information/application server 120. If the user is a new user, then in operation 350, a download of the user application is provided to the user device 100 of the new user and the setup process for the user application is begun.

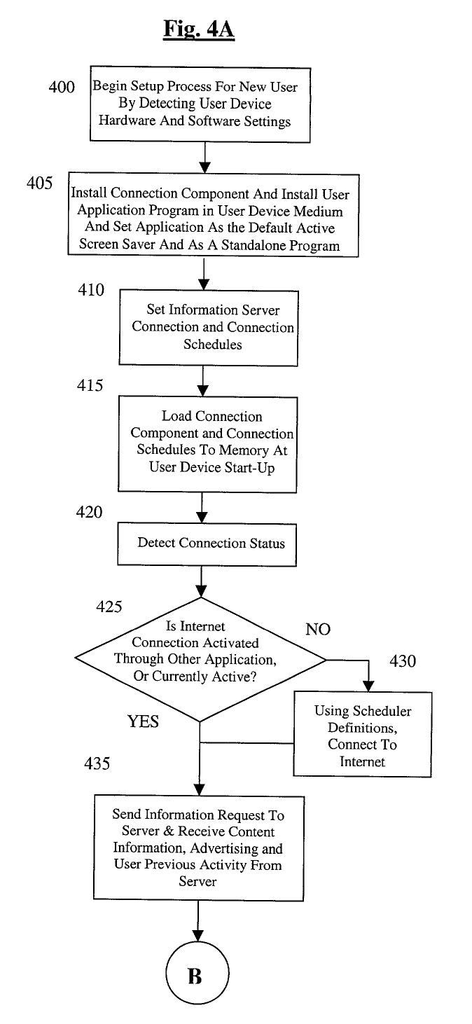

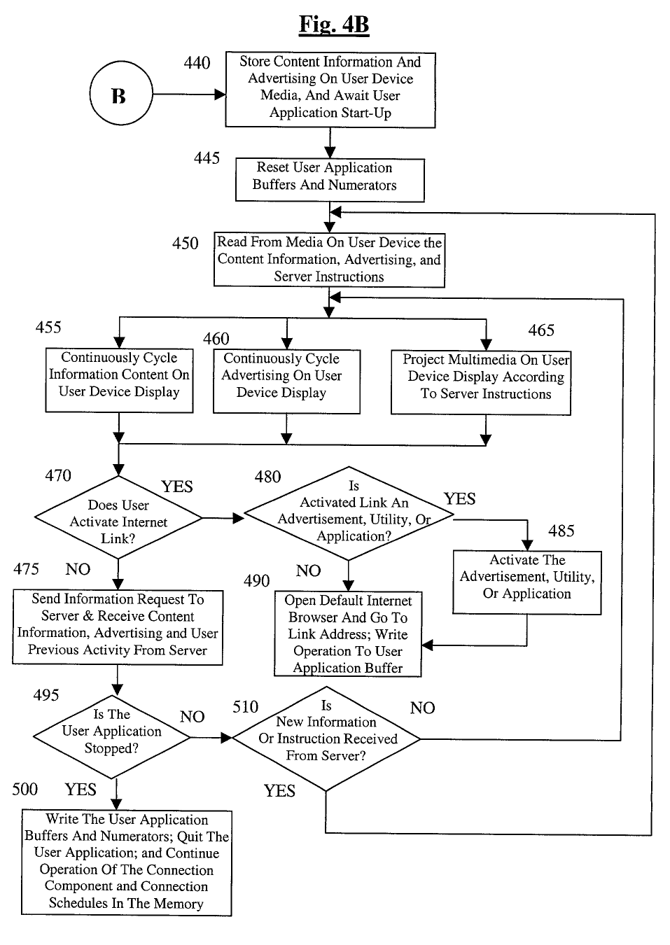

With reference to FIG. 4A, the setup process for the new user is described. As illustrated in the flow chart, in operation 400, the hardware and software settings of the new user device 100 are detected and the appropriate application program is downloaded to the new user device 100. Then, in operation 405, the connection component of the user application and the application program itself are installed on the new user device 100. This installation may occur, in a memory of the new user device 100, or on a computer readable medium such as a disk drive. According to the previously detected settings, the information server connection and the user determined connection schedules are set, for example, in the user device memory. The information server connection information may be, for example, the I.P. address of the information server 120 in a conventional network using Internet Protocol (I.P.) addressing. The connection component and schedules are then loaded into the user device memory at the start up of the user device 100 in operation 415. In operation 420, the connection status, i.e., whether the user device 100 is connected on line through the Internet, is determined. In operation 425, a determination is made as to how the device 100 is connected to the Internet. If the device 100 is not previously connected to the Internet through another application, or is not otherwise currently connected, then using the definitions set in the scheduler (connection schedules) a connection is made to the Internet. In operation 435, a information request is sent to the information server 120 and in response thereto, content information, advertising and a record of user's previous activity are received from the information server 120.

With reference to FIG. 4B, the user application will be described in operation 440. The content information and advertising received by the user device 100 is stored on a computer readable medium of the user device 100 awaiting startup of the user application. Startup of the user application may include activation by the user, or by the expiration of a predetermined period of time in which no user input is received by the user device 100, i.e., activation of a screensaver application. In operation 445, the user application buffers and numerators are reset at the startup of the user application. In operation 450, the content information, advertising and server instructions are read from the computer readable medium on the user device 100 and the content information and advertising are displayed on a display of the user device 100. The content information which may include a variety of multimedia or text information is displayed simultaneously with advertising on the user device display. A secondary application and/or a utility may also be displayed simultaneously with the content information and advertising on the user device display. In operation 455, the content information, for example, news headlines, sport scores and stock price quotations are continuously cycled until interruption by the user. This interruption may be, for example, input to the user device 100 from the user on a keyboard or keypad. In operation 460, portal selected advertising is similarly displayed. In operation 465, multimedia content information may be displayed on a display of a user device 100 according to instructions received from the information application server 120. In operation 470, a determination is made whether the user activates an Internet link within the content information and/or advertising. If so, the application advances to operation 480. Otherwise, the application advances to operation 475. In operation 475, an information request is sent from the user device 100 to the information server 120 requesting updated content information and advertising, as well as user activity information. The process of operation of the application then continues to operation 495. In operation 480, when an Internet link is activated by the user, a determination is made as to whether the activated link is part of an advertisement, secondary application and/or utility or the activated link was part of the use selected content information. If the activated link was part of an advertisement or utility, then in operation 485, the advertisement, utility or secondary application is activated (launched), and the application continues to operation 490. In operation 490, the default Internet browser is opened (launched) and the browser is set so as to open the Internet (I.P.) address embedded in the activated link. The operation is written into a buffer of the user application, and the web page or web site or utility is activated by the Internet browser. Alternately, in operation 495, a determination is made as to whether the user application has been stopped (halted). If so, then in operation 500, the buffers and numerators are written to (set), the user application is halted (quit), and the connection component and schedules are maintained in the user device memory to automatically connect with the information server 120 to obtain updated content information and advertising. In operation 510, a determination as to whether new information and/or instructions have been received from the information server 120. If not, then the application program continues to cycle the information and advertising as described in operations 455, 460 and 465. Otherwise, the information continues to operation 450 in which the received information is read by the user device 100 as previously described.

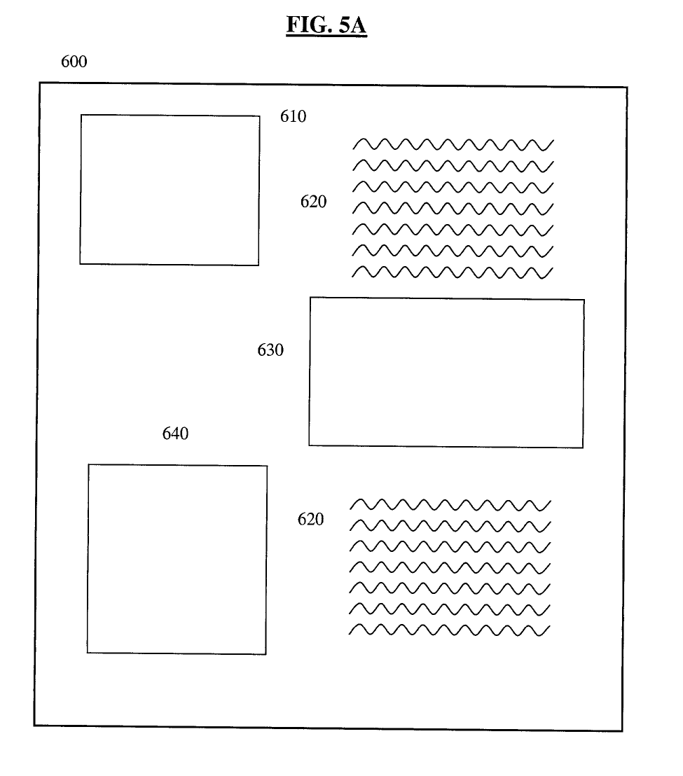

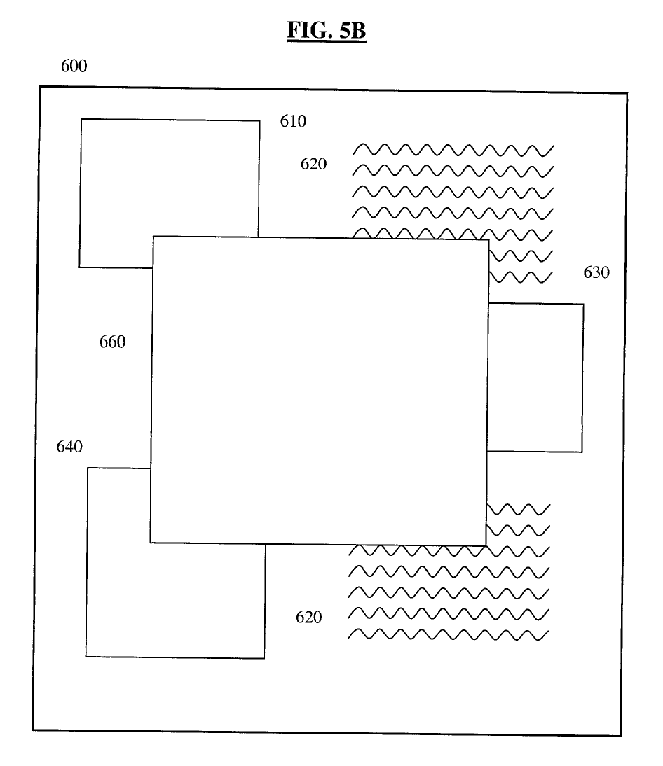

Referring now to FIGS. 5A and 5B, a schematic display of a user device 100 operating the inventive application according to an illustrative embodiment of the present invention is described. The display 600 of the user device 100 shows a variety of information including a utility or secondary application 610 operating on the display 600, content information in the form of text 620 or multimedia 630, and portal selected advertising 640. The secondary application or utility may include a clock, an interactive game or similar useful program running on the user device 100 in the screen saver with periodic updates from the server 120. In FIG. SB, the settings for the application, in the form of a setting window 660, are displayed on the user device 100. These settings may include the schedule for accessing the information server 120 by the user device 100, the method of connection between the user device 100 and the information server 120, the application appearance (display) settings, etc. The information displayed (620 and 630) may also include “buttons” for accessing the settings window 660, as well as a variety of other functions, such as a help window, links to the content information provider, a “pause” button and an “exit” button.

It may be recognized and anticipated, as is evident from the foregoing description, that certain aspects of the present invention are not limited by the particular details of the examples illustrated herein, and it is therefore contemplated that other modifications and applications or equivalents thereof, will occur to those skilled in the art. It is accordingly intended that the claims shall cover all such modifications and applications that do not depart from the spirit and scope of the present invention.

The description above discusses the storage of software in a computer readable medium. Such medium may include, without limitation, a read only memory (“ROM”), a random access memory (“RAM”), a floppy disk, a hard disk, an optical disk, a carrier wave (e.g. a carrier wave transmitted via the internet, a vertical blanking interval of a television signal, etc.), or any other computer readable medium.

Other aspects, objects and advantages of the present invention may be obtained from a study of the drawings, disclosure and the appended claims.

What is claimed is:

1. A method of displaying user selected content information and portal selected advertising on a user device, comprising:
receiving from a remote information server at a portal a first group of user selected content information and a first group of portal selected advertising information according to a schedule predefined by a user;
storing the first group of user selected content information and the first group of portal selected advertising information on a storage medium of the user device;
detecting by the user device a predetermined period in which no user input is received by the user device;
displaying simultaneously on the user device the first group of user selected content information and the first group of portal selected advertising information after the predetermined period has elapsed from the storage medium of the user device;
cycling between portions of the first group of user selected content information automatically without input from the user; and
cycling between portions of the first group of portal selected advertising information automatically without input from the user.

2. The method as set forth in claim 1, wherein the first group of user selected content information and the first group of portal selected advertising information are displayed simultaneously on the user device after the predetermined period in a screen saver program of the user device.

3. The method as set forth in claim 1, further including:
accessing a second group of user selected content information corresponding to the first group of user selected content information by an Internet browsing program stored on the user device, in response to a user request; and
displaying the second group of user selected content information on the user device.

4. The method as set forth in claim 1, further including:
accessing a second group of advertising information corresponding to the first group of portal selected advertising information by an Internet browsing program stored on the user device, in response to a user request; and
displaying second group of advertising information on the user device.

5. The method as set forth in claim 1, further including:
pausing the automatic cycling of the first group of user selected content information in response to a user request.

6. A computer system for displaying user selected content information and portal selected advertising, comprising:
means for receiving a first group of user selected content information and a first group of portal selected advertising information from a remote information server according to a schedule predefined by a user;
means for storing the first group of user selected content information and the first group of portal selected advertising information;
means for detecting a predetermined period in which no user input is received;
means for simultaneously displaying the first group of user selected content information and the first group of portal selected advertising information after the predetermined period has elapsed;
means for cycling between portions of the first group of user selected content information automatically without input from the user; and
means for cycling between portions of the first group of portal selected advertising information automatically without input from the user.

7. A computer system for displaying user selected content information and portal selected advertising, comprising:
a remote information server;
a user device including:
a processor;
a display;
a storage medium; and
an interface;
the interface operable to receive a first group of user selected content information and a first group of portal selected advertising information from the remote information server according to a schedule predefined by a user;
the storage medium operable to store the first group of user selected content information, the first group of portal selected advertising information and the predefined schedule;
the processor operable to detect a predetermined period in which no user input is received by the computer system;
the processor operable to simultaneously display the first group of user selected content information and the first group of portal selected advertising information on the display after the predetermined period has elapsed;
the processor operable to cycle between portions of the first group of user selected content information automatically without input from the user; and
the processor operable to cycle between portions of the first group of portal selected advertising information automatically without input from the user.

8. The computer system according to claim 7, wherein the user device is one of a group consisting of a personal computer, a computer terminal, a PDA, and a wireless telephone.

9. The computer system according to claim 7, wherein the interface of the user device is operable to receive the first group of user selected content information and the first group of portal selected advertising information transmitted from a remote information server over the Internet.

10. The computer system according to claim 7, wherein the interface of the user device is operable to receive the first group of user selected content information and the first group of portal selected advertising information transmitted from a remote information server using wireless communication.

11. The computer system according to claim 10, wherein the wireless communication follows the Wireless Application Protocol (WAP).

12. The user device according to claim 7, wherein the processor of the user device is operable to access a second group of user selected content information corresponding to the first group of user selected content information by operation of an Internet browsing program stored on the storage medium of the user device, in response to a user request; and the processor of the user device is operable to display the second group of user selected content information on the display of the user device.

13. The user device according to claim 7, wherein the processor of the user device is operable to access a second group of advertising information corresponding to the first group of portal selected advertising information by operation of an Internet browsing program stored on the storage medium of the user device, in response to a user request; and the processor of the user device is operable to display the second group of advertising information on the display of the user device.

14. The user device according to claim 7, wherein the processor of the user device is operable to pause the automatic cycling of the first group of user selected content information in response to a user request.

15. The user device according to claim 7, wherein the processor of the user device is operable to access a secondary application, and is operable to display the secondary application.

16. A computer program product for enabling a user device to display user selected content information and portal selected advertising, comprising:
a computer readable medium; and
instructions on a computer readable medium, for
providing a first group of user selected content information and a first group of portal selected advertising information according to a schedule predefined by a user;
storing the first group of user selected content information, and the first group of portal selected advertising information;
detecting a predetermined period in which no user input is received by the computer system;
displaying simultaneously the first group of user selected content information and the first group of portal selected advertising information on a display of the user device after the predetermined period has elapsed;
cycling between portions of the first group of user selected content information automatically without input from the user; and
cycling between portions of the first group of portal selected advertising information automatically without input from the user.

17. The computer program product according to claim 16, further including instructions on the computer readable medium, for:
responding to a user request;
accessing a second group of user selected content information corresponding to the first group of user selected content information by operation of an Internet browsing program stored on the computer readable medium, in response to the user request;
displaying the second group of user selected content information on the display of the user device.

18. The computer program product according to claim 16, further including instructions on the computer readable medium, for:
responding to a user request;
accessing a second group of advertising information corresponding to the first group of portal selected advertising information by operation of an Internet browsing program stored on the computer readable medium, in response to the user request;
displaying the second group of advertising information on the display of the user device.
